(19) United States
(12) Patent Application Publication
(10) Pub. No.: US 2016/0307426 A1
(43) Pub. Date: Oct. 20, 2016

(54) BABYSTAR - Alert system for babies left unattended in a car

(71) Applicants: Carlson DeAlmeida Barros, Orlando, FL (US); Dennis Benaglia Munhoz, Sao Paulo (BR)

(72) Inventors: Carlson DeAlmeida Barros, Orlando, FL (US); Dennis Benaglia Munhoz, Sao Paulo (BR)

(21) Appl. No.: 14/686,409

(22) Filed: Apr. 14, 2015

(51) Int. Cl. G08B 21/02; B60Q 9/00; H04W 4/14; H04M 1/725; H04W 4/00; H04L 12/58

(52) U.S. Cl. CPC G08B 21/0277; H04W 4/008; H04L 51/38; H04W 4/14; H04M 1/7253; B60Q 9/00

(57) ABSTRACT

An alert system composed of a Bluetooth device that is installed in a baby car seat and is paired/connected to one or more smartphones or tablets using a monitoring application developed for this purpose, which receives the signal communicated from the device installed in the baby car seat and stays connected within a 15 feet range. The application immediately produces a vibrating sound alert, and displays a notification message as soon as the smartphone crosses the 15 feet boundary range.

### BACKGROUND OF THE INVENTION

1. Field of Invention

The present invention relates to an alert system for babies left unattended in a car.

2. Description of Related Art

There were 30 heatstroke deaths of different aged children left in vehicles in 2014, and at least 45 deaths of the same cause in the previous year, 2013, in the United States. The fact is that under many circumstances people forget children inside vehicles that can reach life-threatening temperatures very quickly. Consequently it's imperative that people be reminded of their children inside their vehicles. Consequently it would be advantageous to have an alert system to help remind them.

### SUMMARY OF THE INVENTION

The present invention relates to an alert system comprising: a Bluetooth device transmitter; a casing; a battery compartment within the casing; where the battery compartment has a part for a rechargeable battery; an on/off switch in one side of the casing; next to the on/off switch there is a set-up switch where the user presses to set-up a connection to his/her smartphone; and a monitoring application for smartphones built to produce: a vibrating sound alert and also displays a notification as soon as the smartphone crosses a 15 feet boundary range limit and loses the Bluetooth connection. The application may include the ability to send text messages and emails to other pre-selected smartphones/tablets/email addresses.

### BRIEF DESCRIPTION OF THE DRAWINGS

FIG. 1=Depicts the alert system block diagram in accordance with the present invention.

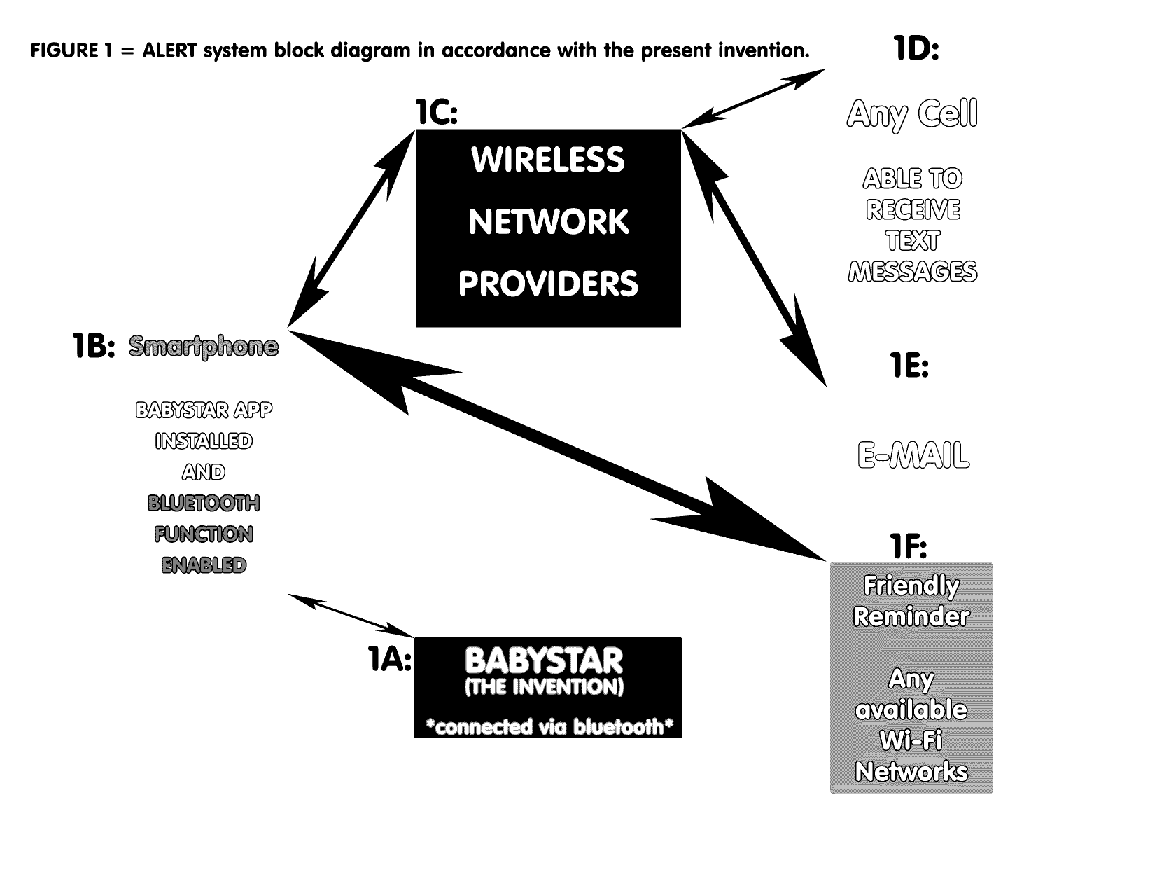

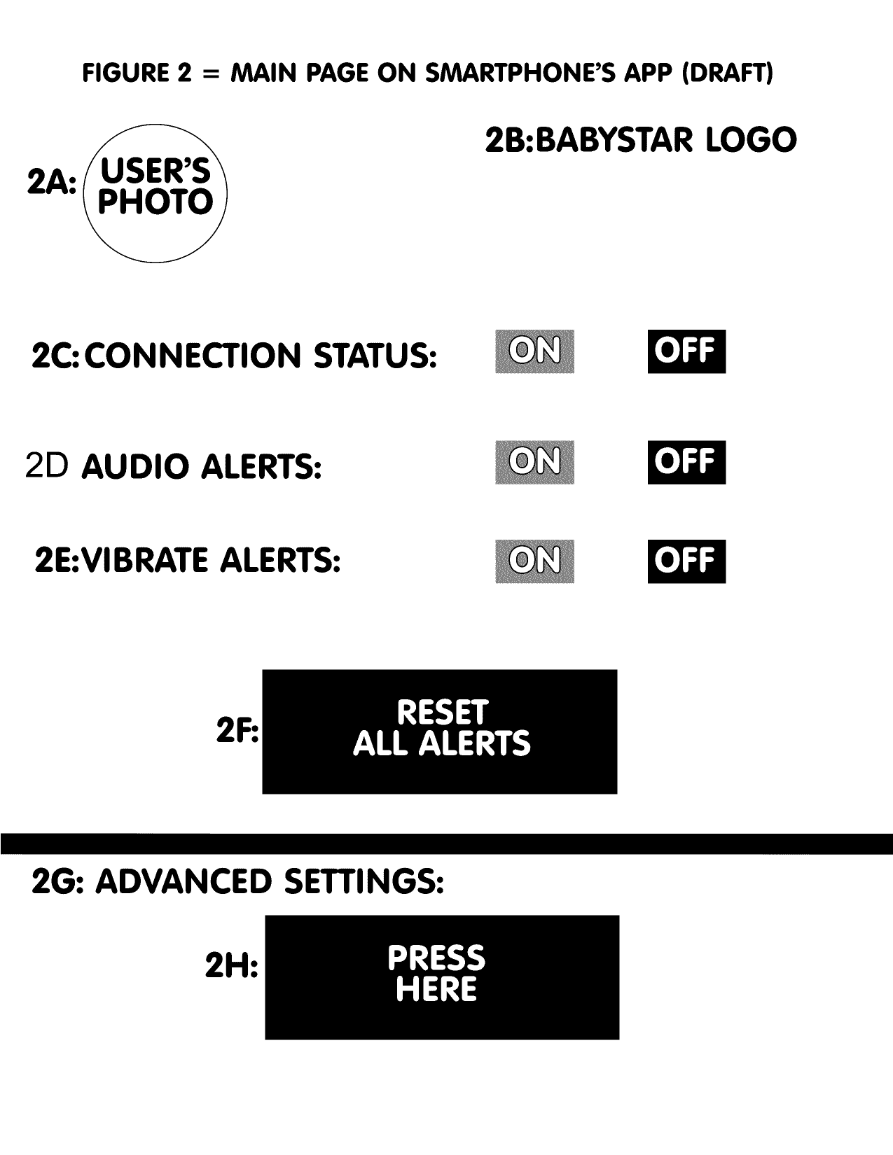

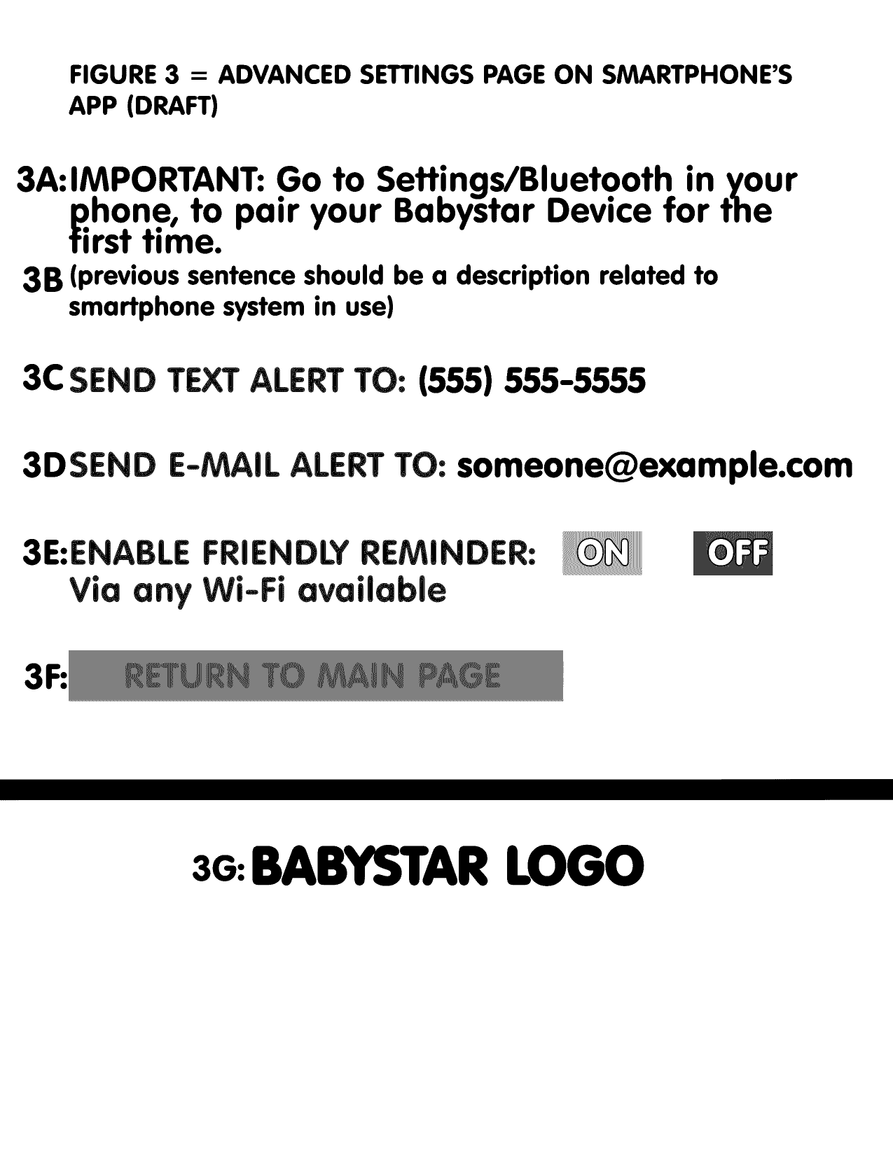

1A: Device transmitter built to utilize Bluetooth technology to communicate to an enabled Bluetooth smartphone or tablet. Related to claims 1 to 3.

1B: An application installed onto a smartphone that, when in execution communicate with the device transmitter on letter A. Related to claims 4 to 14.

1C: Wireless network provider of the person who is taking care of the baby and also the wireless network provider of the person who is receiving the alerts, which doesn't need to be the same company. Related to claim 5.

1D: Pre-selected smartphones/tablets via BABYSTAR onto the smartphone application of the person who is taking care of the baby. Related to claim 9.

1E: Pre-selected email addresses, via BABYSTAR application onto the smartphone of the person who is taking care of the baby. Related to claim 10

1F: Any available Wi-Fi networks without the need to join it. Related to claims 13 and 14.

FIG. 2=Depicts a draft of the main page on smartphone app in accordance with the present invention.

2A: Customizable User's photo area.

2B: BABYSTAR Logo to be announced.

2C: Bluetooth connection status, between the cell phone and the BABYSTAR device.

2D: Audio alerts status, onto the smartphone of the person taking care of the baby.

2E: Vibration alerts status, onto the smartphone of the person taking care of the baby.

2F: “RESET ALL ALERTS Button” on BABYSTAR Smartphone Application onto the smartphone of the person taking care of the baby.

2G: Advanced settings portion of the Main page on BABYSTAR Smartphone Application onto the smartphone of the person taking care of the baby.

2H: “Press here Button” to access advanced settings page on BABYSTAR Smartphone Application onto the smartphone of the person taking care of the baby.

FIG. 3=Depicts a draft of the advanced settings page on smartphone app in accordance with the present invention.

3A: Brief instructions to help the person who is taking care of the baby to connect his/her smartphone to BABYSTAR device transmitter which is built to connect using Bluetooth technology.

3B: This sentence may not be included but explains the USPTO examiner that the sentence on item A: will be customized to the smartphone's operational system in use for the person who is taking care of the baby, such as: iOS. Android or Windows.

3C: Pre-selected smartphone from a second person. Other than the person who is taking care of the baby.

3D: Pre-selected email or multiple e-mails. From the person who is taking care of the baby and/or other person.

3E: Friendly Reminder via any Wi-Fi available status.

3F: Return to Main Page Button.

### DETAILED DESCRIPTION

It's an alert system composed of a Bluetooth device transmitter powered by rechargeable batteries, that is easily installed on a baby car seat in a safe place where the baby can not reach (like the back of the baby car seat) and, is paired/connected to one or more smartphones or tablets operating within a wireless network that are used as receivers.

The application installed in the smartphone produces: a vibrating sound alert and displays a notification as soon as the smartphone crosses the 15 feet boundary range limit and loses the Bluetooth connection.

After the initial set-up executed by the person in charge with the care of the baby, the system keeps running even after exiting the application.

The system automatically (after the first initial set-up) connects when the Smartphone and the Bluetooth device installed on the baby car seat approximate each other. Both the Smartphone and Bluetooth devices should have their batteries charged for all functions to work properly.

The application also has the ability to send text messages and emails to other pre-selected smartphones/tablets/email addresses in case the person who is taking care of the baby doesn't respond to the 15 feet boundary triggered alerts within 1 minute.

The application will keep reminding the person in charge of the baby and the pre-selected smartphones/tablets/email addresses until the authorized user reset the alerts inside the BABYSTAR application.

As a backup system, the application also has the ability to identify available Wi-Fi networks without the need to join it (in department stores, shopping centers, pharmacies, grocery stores, homes, public wi-fi, schools, etc.) and trigger the vibrating and sound alert notification.

What is claimed is:

1. An alert system for babies left unattended in a car comprising: a. a casing; b. a battery compartment within the casing, where the battery compartment has a part for a rechargeable battery; c. an on/off switch in one side of the casing; d. a set-up switch next to the on/off switch where the user presses to set-up a connection to his/her smartphone; e. and a monitoring application for smartphones built to produce: a vibrating sound alert and also displays a notification as soon as the smartphone crosses a 15 feet boundary range limit and loses the Bluetooth connection. The application may include the ability to send text messages and emails to other pre-selected smartphones/tablets/email addresses.

2. The alert system for babies left unattended in a car according to claim 1, where the application installed onto a smartphone that, keeps reminding the person who is taking care of the baby and send emails to other pre-selected smartphones/tablets/email addresses in case the person who is taking care of the baby doesn't respond to the 15 feet boundary triggered alerts within 1 minute; until the authorized user resets the alerts.

3. The alert system for babies left unattended in a car according to claim 1, where the application installed onto smartphone that, when in execution communicates with other devices and technologies such as but not limited to: Wi-Fi routers, and identify any open or closed Wi-Fi networks without the need to join it (in department stores, shopping centers, pharmacies, grocery stores, schools, etc.) and triggers the vibrating and sound alert notification using the smartphone wireless capabilities of the person who is taking care of the baby.
